(19) United States
(12) Patent Application Publication
(10) Pub. No.: US 2018/0182041 A1
(43) Pub. Date: Jun. 28, 2018

(54) Systems and Methods for Wide-Scale Mapping of Neighborhood Property Geolocations and Estimating Property Values Thereof

(71) Applicant: AON GLOBAL OPERATIONS LTD (SINGAPORE BRANCH), Singapore (SG)

(72) Inventors: Barry SHERIDAN, Mountjoy (IE); Emma LYNCH, Mountjoy (IE)

(73) Assignee: AON GLOBAL OPERATIONS LTD (SINGAPORE BRANCH), Singapore (SG)

(21) Appl. No.: 15/852,960

(22) Filed: Dec. 22, 2017

Related U.S. Application Data
(60) Provisional application No. 62/439,222, filed on Dec. 27, 2016.
(60) Provisional application No. 62/439,241, filed on Dec. 27, 2016.
(60) Provisional application No. 62/439,227, filed on Dec. 27, 2016.

(51) Int. Cl. G06Q 40/08; G06F 17/30

(52) U.S. Cl. CPC G06Q 40/08; G06F 17/30241

(57) ABSTRACT

In an illustrative embodiment, systems and methods for identifying properties affected or at risk of being affected by geohazards include obtaining geospatial data representing geographic features and associated geohazard risk with a portion of the features, applying, based on a storage size of the geospatial data, a shape approximation algorithm to geographic shape representations of a geographic area within the geospatial data to reduce the storage size, mapping, to the geospatial data, property data representing a number of manmade features, and adjusting, based on periodically released geospatial data updates accessed from one or more hazard data providers, the geospatial data to incorporate a time element mapping modifications to a portion of elements in the geospatial data, where the resultant geospatial data is maintained in a database for querying to identify impact of geohazards upon property values of a portion of the manmade features.

### RELATED APPLICATIONS

This application claims priority to the following: U.S. Provisional Patent Application Ser. No. 62/439,222 entitled “Systems and Methods for Wide-Scale Mapping of Neighborhood Property Geolocations and Estimating Property Values Thereof,” filed Dec. 27, 2016, U.S. Provisional Patent Application Ser. No. 62/439,241 entitled “Methods and Systems for Storing and Querying Geospatial Data and for Producing Multi-Layer Visualization Graphics Therefrom” filed Dec. 27, 2016, and U.S. Provisional Patent Application Ser. No. 62/439,227 entitled “Systems and Methods for Converting Descriptive, Time-Variant Datasets to a Geospatial Domain” filed Dec. 27, 2016. All above identified applications are hereby incorporated by reference in their entireties.

### BACKGROUND

Geospatial data files are typically very large and unwieldy. For example, Geographic Information Systems (GIS) data relates information through location coordinates, such as longitude-latitude-elevation. Features may then be attached to coordinates and defined in space through the use of points, lines, and polygons. Complexity of the data set may be directly related to the complexity of the data itself (e.g., the shape of a broken, rocky coast is more intricate than the shape of a Midwest highway). The GIS data is stored within a database construct such that information is derived from the mapping data via database queries.

Storing and querying large volumes of geospatial data may impose limits on transfer of data between systems. Although data compression of the files may reduce the size and improve transfer performance, the high computational cost may limit real-time applications. In addition, set transformations (i.e. intersections) within the geospatial data may fail to produce appropriate results due to so-called “self-intersections,” which can occur when a geospatial data generation method generates shapes that cross themselves, which may lead to poor shape file integrity.

As a further complication, mappable information is rarely static. Land features alter through the force of nature or human development, such as the paths of rivers, the impounding of bodies of water through creation of dams, or the blasting of bedrock to create new roadways or to enable additional real estate development. Thus, multiple sets of complex mapping information have been stored to capture these changes, but to conserve storage space government mapping systems typically maintain only a limited time window for historic analysis.

The inventors recognized a need for an improved system to better track changes in geographic hazards such as flood zones. In combining geographic hazard information with additional layers of mapping features, the data may be analyzed and mined to identify potential community impact, in damages and costs, due to changes in geographic hazards. Further, the inventors conceived of an improved storage mechanism to store mapping information such that historic movements within the mapping data (e.g., of flood zone movements, etc.) can be readily analyzed and monitored. Additionally, the improved storage mechanism reduces storage requirements in comparison to conventional map data storage.

### SUMMARY OF ILLUSTRATIVE EMBODIMENTS

The forgoing general description of the illustrative implementations and the following detailed description thereof are merely exemplary aspects of the teachings of this disclosure, and are not restrictive.

In one aspect, systems and methods are described for efficiently storing high resolution geospatial files by reducing the number of shape-defining points such that the shapes retain as much of their important features as possible. In certain embodiments, a geospatial publishing driver functions as an intermediary between spatially enabled database management systems and a visualization front-end to smooth and streamline the database query process. The systems and methods may include implementing a complex, multi-layered geospatial visualization technique with automated query filtering.

In one aspect, systems and methods are described for automatically tracking the time variant datasets representing movements in the geographical features and geohazards. The data changes may be converted into a geospatial domain useful in identifying impact upon properties residing in the affected areas.

In one aspect, the present disclosure describes systems and methods for identifying properties within geospatial coordinates affected or potentially affected by geohazards. For example, through combining disparate datasets of multiple layers of property characteristics with geospatial data in a geospatial domain, a unique method of defining value for properties can be built that considers geohazard data in valuation. In some embodiments, systems and methods include using software tools to quickly composite geospatial datasets together to generate new flood risk maps that are a function of factors that supplement the FIRM flood zones. In some embodiments, computing systems implement risk modelling tools that allow an insurance provider to calculate average annual loss and probable maximum loss sensitivities and produce general loss curves. In some implementations, real-time changes to FEMA flood zones may be tracked for property owners across the United States.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is a block diagram of an example environment for an enhanced lead generation system;

FIG. 2 is a flow chart of an example method for constructing and executing a database query;

FIG. 3 is a flow chart of an example method for gathering flood map updates from one or more flood map providers;

FIG. 4 is a flow chart of an example method for gathering property value information from internet-accessible property value providers through web scraping;

FIGS. 5A-5C illustrate an exemplary geospatial file and the effect of simplification of the geospatial geometry on a geospatial file;

FIG. 6 illustrates a flow chart of an example method for preparing multi-layer flood risk map visualizations;

FIG. 7 is a screen shot of an example user interface illustrating flood and property information layers presented upon a street-level map;

FIG. 8 is a screen shot of an example user interface illustrating an enhanced layered street-level map including additional information presented in table form;

FIG. 9 is a block diagram of an example computing system; and

FIG. 10 is a block diagram of an example distributing computing environment including a cloud computing environment.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

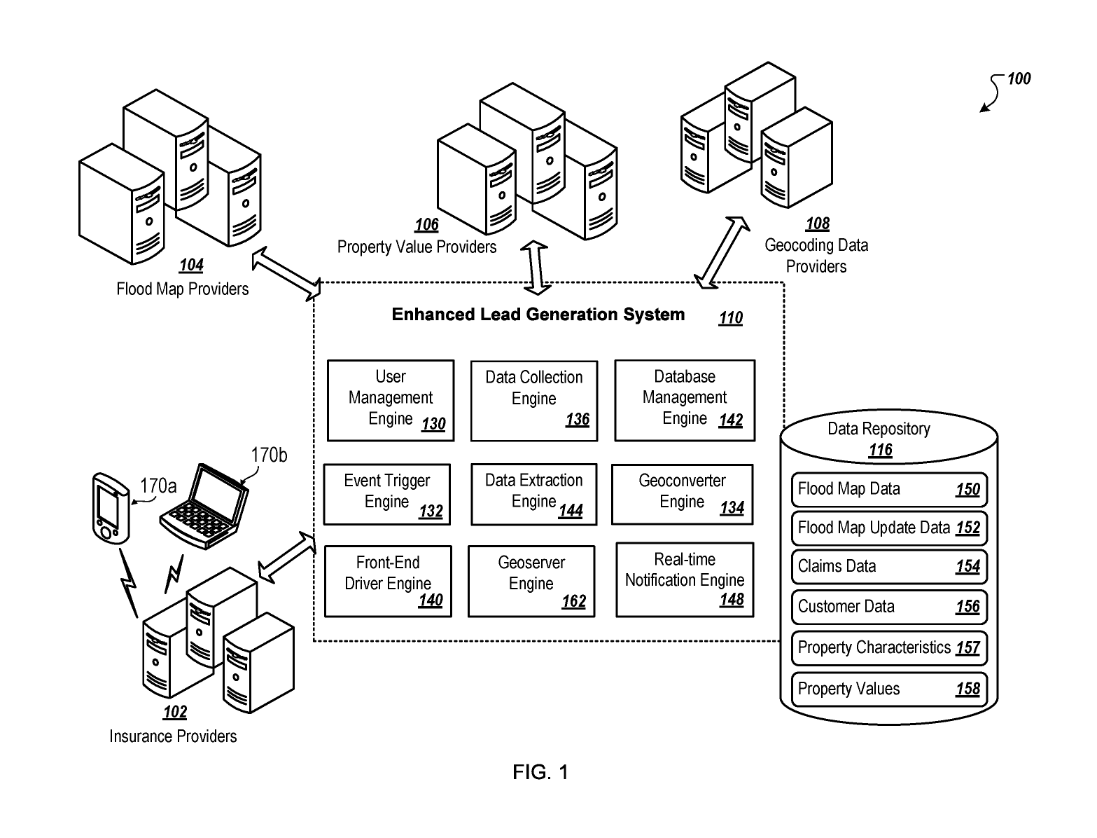

FIG. 1 is a diagram of an example environment 100 for an enhanced lead generation system 110. The diagram illustrates relationships, interactions, computing devices, processing modules, and storage entities used to gather, generate, store, and distribute the information necessary to identify properties whose owners would be considered appropriate customers for flood insurance.

In some implementations, the enhanced lead generation system 110 may gather and process information from sources such as flood map providers 104, property value providers 106, and geocoding data providers 108 and provide information (sales leads, for example) to one or more insurance providers 102 (insurance providers may include, but are not limited to, private insurance companies, financial institutions and government agencies). In some examples, the insurance providers 102 may use the information to build a portfolio of flood insurance customers based on optimizing property risk-to-return ratio. For example, the enhanced lead generation system 110 may receive feedback from insurance providers 102, which may be used to adjust data stored by the lead generation system 110.

In certain embodiments, insurance providers 102 may connect to the lead generation system 110 via a number of computing devices distributed across a large network that may be national or international in scope. The network of insurance providers 102 can be separate and independent from networks associated with other entities in the lead generation environment 100, such as the flood map providers 104, property value providers 106, or geocoding data providers 108. In addition, the data handled and stored by the insurance providers 102 may be in a different format than the data handled and stored by the other entities of the lead generation environment 100.

In some examples, the flood map providers 104 may include the US Federal Emergency Management Agency (FEMA). Instead of or in addition to FEMA, the flood map providers 104 may also include other government agencies (of the US or another country) or may be nongovernmental public or private institutions. In some aspects, the flood map providers 104 may offer a specific set of flood risk products including, but not limited to, Flood Insurance Rate Maps (FIRMs) that may generally show base flood elevations, flood zones, and floodplain boundaries for specific geographic areas (the entirety of the US, for example). In some examples, the flood map providers 104 may also offer periodic and/or occasional updates to flood maps due to changes in geography, construction and mitigation activities, climate change, and/or meteorological events. In some embodiments, the flood map providers 104 may include a number of computing devices and databases which may be localized or may be distributed across a widely dispersed network.

In some implementations, the property value providers 106 may include a number of computing devices and databases that may be localized or distributed across a widely dispersed network. The network of property value providers 106 can be separate and independent from networks associated with other entities in the lead generation environment 100, such as the flood map providers 104, geocoding providers, or insurance providers 102. In addition, the data handled and stored by the property value providers 106 may be in a different format than the data handled and stored by the other entities in the lead generation environment 100.

In some examples, the property value providers 106 may provide inputs to the enhanced lead generation system 110 that may include property values. For example, property values from the property value providers 106 may be based on public records (tax assessments, real estate sales, and the like), multiple listing service (MLS), or may be based on specific and, in some cases, proprietary appraisals of individual properties and/or groups of properties. In some examples, the data provided to the enhanced lead generation system 110 from the property value providers 106 may be independent from the other entities and in a different format than the data provided by the flood map providers 104, geocoding providers, and insurance providers 102. For example, the enhanced lead generation system 110 may pull or extract property value data from the property value providers 106 using so-called web scraping (web harvesting or web data extraction) from public or private websites. Alternatively, the enhanced lead generation system 110 may operate under a contractual agreement with one or more property value providers 106 to provide property values.

In some embodiments, the geocoding data providers 108 may include a number of computing devices and databases distributed across a widely dispersed network that may be distributed across a large, international geographic area. The network of geocoding data providers 108 can be separate and independent from networks associated with other entities in the lead generation environment 100, such as insurance providers 102, flood map providers 104, or property value providers 106. In addition, the data handled and stored by the geocoding data providers 108 may be in a different format than the data handled and stored by the other entities in the lead generation environment 100. In some examples, the geocoding data providers 108 provide inputs to the enhanced lead generation system 110 that may include property characteristics 157. For example, property characteristics 157 provided by the geocoding data providers 108 may include, but are not limited to, address, descriptive statistics, location coordinates, and footprint. The data provided to the enhanced lead generation system 110 from the geocoding data providers 108 may be independent from the other entities and in a different format than the data provided by the insurance providers 102, flood map providers 104, or property value providers 106.

In some embodiments, the enhanced lead generation system 110 may include one or more engines or processing modules 130, 132, 134, 136, 140, 142, 144, 148, 162 that perform processes associated with identifying and qualifying candidates for flood insurance. In some examples, the processes performed by the engines of the enhanced lead generation system 110 can be executed in real-time in order to provide an immediate response to a system input. In addition, the processes can also be performed automatically in response to a process trigger that can include a specific day or time-of-day or the reception of data from a data provider (e.g., one of the flood map providers 104, property value providers 106, or geocoding data provider 108), one of the insurance providers 102, or another processing engine.

In some implementations, the enhanced lead generation system 110 may include a user management engine 130 that may include one or more processes associated with providing an interface to interact with one or more users (e.g., individuals employed by or otherwise associated with insurance providers 102) within the lead generation environment 100. For example, the user management engine 130 can control connection and access to the enhanced lead generation system 110 by the insurance providers 102 via authentication interfaces at one or more external devices 170 of the insurance providers 102. In some examples, the external devices 170 may include, but are not limited to, personal computers, laptop/notebook computers, tablet computers, and smartphones.

The enhanced lead generation system 110, in certain embodiments, may also include a data collection engine 136 that controls the gathering of data from the flood map providers 104, property value providers 106, and geocoding data providers 108. In some examples, the data collection engine 136 can typically receive data from one or more sources that may impact lead generation for insurance providers 102. For example, the data collection engine 136 can perform continuous, periodic, or occasional web crawling processes to access updated data from the flood map providers 104, property value providers 106, and geocoding data providers 108. The data collection engine 136 may also monitor flood insurance claims settlement processing systems and automatically update claims data 154 and customer data 156 for each claim settlement that occurs.

In addition, the enhanced lead generation system 110 may include, in some implementations, a database management engine 142 that organizes the data received by the enhanced lead generation system 110 from the flood map providers 104, property value providers 106, and geocoding data providers 108. In some examples, the database management engine 142 may also control data handling during interaction with insurance providers 102. For example, the database management engine 142 may process the data received by the data collection engine 136 and load received data files to data repository 116, which can be a database of data files received from the one or more data sources. In one example, the database management engine 142 can determine relationships between the data in data repository 116. For example, the database management engine 142 can link and combine received geospatial data with property characteristics 157, property values 158, claims data 154, and/or customer data 156. In addition, the database management engine 142 may perform a data format conversion process to configure the received data into a predetermined format compatible with a format of the files within data repository 116. For example, the database management engine 142 may process geospatial data received from the geocoding data providers 108 to reduce the data storage and/or communication requirements for the geospatial files.

In some implementations, the database management engine 142 may be used to efficiently store and manage large quantities of geospatial data, which may make up at least a portion of the data stored in the data repository 116, such as the flood map data 150, flood map update data 152, and/or property characteristics 157. The efficient storage and use of geospatial data may be facilitated by the use of an object-relational database system that can provide support for configuring geometric and geographic objects for storage and enable querying of geospatial data and creating a visualization component to visualize the geospatial data.

In some examples, at least a portion of the data repository 116 may include an object-relational database management system, which is a database system similar to a relational database, but with an object-oriented database model. Specifically, objects, classes and inheritance may be directly supported in database schemas and in the query language. Additionally, in some aspects, an object-relational database system may support extension of the data model with custom data-types and methods.

In some embodiments, adding support for geographic objects to an object-relational database “spatially enables” the object-relational database system. For example, a spatially enabled object-relational database management system may store and manipulate spatial objects like any other object stored within the database. In some examples, spatial data types such as points, lines, polygons, and other geometric objects may be supported in the spatially enabled object-relational database management system. Additionally, in some aspects, multi-dimensional spatial indexing may be employed for efficient processing of spatial operations.

In some implementations, spatial functions, posed in a database query language, may be used for querying the database management engine 142 and the spatial data, properties, and relationships within the data repository 116. In some examples, the database management engine 142 may provide a rich set of functions for analyzing geometric components, determining spatial relationships, and manipulating geometries, and these spatial functions may serve as building blocks for complex spatial queries.

In some implementations, a majority of the spatial functions performed by the object-relational database management system can be grouped into one of the following five categories:
Conversion: Functions that convert between geometries and external data formats.
Management: Functions that manage information about spatial tables and database administration.
Retrieval: Functions that retrieve properties and measurements of a geometry.
Comparison: Functions that compare two geometries with respect to their spatial relation.
Generation: Functions that generate new geometries from others.

In some implementations, the enhanced lead generation system 110 may also include a front-end driver engine 140 that controls dissemination of data and interactions with insurance providers 102 through one or more user interface (UI) screens that may be output to the external devices 170 in response to queries received from the insurance providers 102. For example, the insurance providers 102 may select and/or input geographic or other selection criteria on a UI screen. In response to receiving the inputs at the UI screen, the front-end driver engine 140 may output geospatial data (flood map data 150 and the like) that identify one or more properties that meet predetermined or selected criteria for a flood risk profile.

In some implementations, the front-end driver engine 140 may cause geospatial data to be displayed on the front-end UI to allow a user to interact with the information stored in the data repository 116. In one example, the front-end of the enhanced lead generation system 110 may be implemented as a web application that a user (e.g., insurance provider 102) accesses through a web browser running on external devices 170. In some embodiments, the front-end of the system 110 may also be a full-fledged application or mobile app that runs on external devices.

In some implementations, the features provided by the front-end driver engine 140 may include the ability to dynamically combine and render layers detailing property values, flood risk based on flood risk map data, historical claim data, flood risk properties, and map/satellite layer infrastructure. Additional features provided by the front-end driver engine 140, in some examples, may include the ability to dynamically toggle layer opacity and visibility, save local map screen-shots, query properties as a function of zoom height, download lists of properties satisfying layer queries, and conduct location based searches in response to inputs received from a user (e.g., insurance provider 102). In some embodiments, the front-end driver engine 140 may also provide the ability for a user to select an area and view, in real-time, the most valuable properties to target for flood insurance.

In some implementations, in response to receiving a user query, the front-end driver engine 140 may execute a filtering step prior to generating query results so that only insurable properties are provided as query outputs at the front-end UI, which may reduce or prevent providing results that include areas of land that may not fall under the targetable properties (e.g., parks, public amenities).

The enhanced lead generation system 110, in some implementations, may also include a geoserver engine 162 that may provide the capability to quickly composite geospatial datasets together to generate new flood risk maps in response to flood map update data 150 received from the flood map providers 104 and/or geocoding data providers 108, which may provide a seamless interface between the insurance providers 102, front-end driver engine 140, and database management engine 142. In some examples, processing a query from a web browser or other software application running on one of the external devices 170, through the front-end driver engine 140, to the database management engine 142 may require complex manipulations of large amounts of data that may increase the difficulty of providing real-time responses to queries received at the front-end UI.

For example, large rendering operations associated with responding to queries may significantly impair the response time of the system 110 and data repository 116. Additionally, complex, inefficient database queries with no intelligent indexing may further encumber database access, and the large size of geospatial database objects may create substantial bottlenecks in the query process. The geoserver engine 162, in some embodiments, provides a solution to the abovementioned processing difficulties by smoothing and streamlining the query process. In some aspects, the geoserver engine 162 may assist in defining how a query of the data repository 116 is constructed and what type of data is returned by the data repository 116 in response to the received query. In some implementations, the query defining operations performed by the geoserver engine 162 may provide for greater control over the coverage and raw size of the returned data and the complexity of layer interaction.

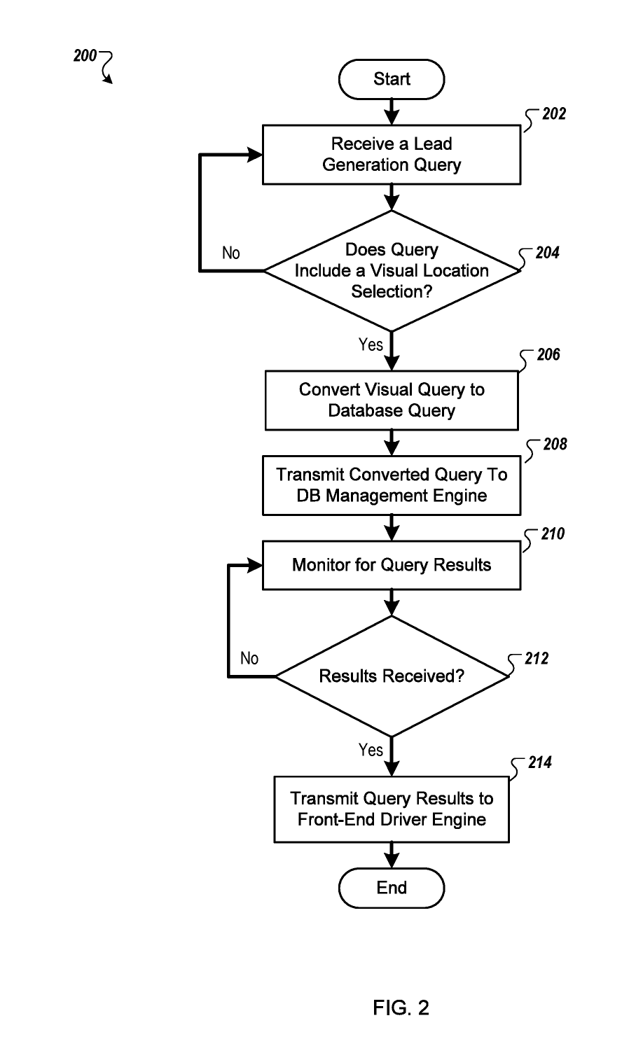

For example, FIG. 2 illustrates a flow chart of an example method 200 for constructing and executing a database query in response to receiving a visual map selection at a user interface provided by the front-end driver engine 140 to a remote computing device. In some examples, the method 200 is performed by the front-end driver engine 140 and geoserver engine 162.

In some implementations, the method 200 commences with receiving a lead generation query at a user interface screen, which may include a visual selection of an area or point (on a map displayed within the user interface, for example) (202). If, in some examples, the query includes a new visual location selection (204), which may correspond to a geospatial data query, then the geoserver engine 162 may convert the visual query to a database query (SQL is an example of a well-known query language) (206). By performing the query conversion, in some embodiments, the geoserver engine 162 streamlines the access of large quantities of complex geospatial data from the data repository 116.

In some implementations, the geoserver engine 162 may transmit the converted database query to the database management engine 142 (208), which may control data loading and access at the data repository 116. Additionally, in some examples, the geoserver engine 162 may monitor the status of the query through communication with the database management engine (210), and if query results are received from the database management engine 142 (212), then the geoserver engine 162, in some examples, may transmit the query results to the front-end driver engine 140 (214), which may be configured to be presented to the user in a user interface screen. In some examples, the query results may include one or more map tiles and additional layers such as property values, flood risk levels, historical claim data, flood risk properties, and/or map/satellite layer infrastructure

Although illustrated in a particular series of events, in other implementations, the steps of the database query construction and execution process 200 may be performed in a different order. For example, monitoring for query results (210) may be performed before, after, or simultaneously with determining whether or not query results have been received (212). Additionally, in other embodiments, the process may include more or fewer steps while remaining within the scope and spirit of the database query construction and execution process 200.

Returning to FIG. 1, in some implementations, the enhanced lead generation system 110 may also include a geoconverter engine 134 that is configured to convert descriptive datasets into the geospatial domain. In some examples, the geoconverter engine 134 may be configured to process descriptive statistics of areas of interest and return the dataset in the geospatial domain. For example, the geoconverter engine 134 may be configured to automatically identify and update a database of recent changes to flood map datasets received from the flood map providers 104.

In some implementations, the geoconverter engine 134 may be configured to generate query results associated with presenting a visual representation of flood zone changes. In some examples, the geoconverter engine 134 monitors these changes by filtering a received FEMA-supplied change list on a periodic basis for “new” changes (e.g., changes added since a most recent update of the geospatial database for flood maps). The FEMA-supplied change list, in one example, identifies changes to the previous versions of flood maps by at least a subset of date, state, county, community, and FEMA ID. The periodic basis, in some examples, can be every other week, every week, every other day, or daily. In some embodiments, the geoconverter engine 134 processes flood map data 150 received from the FEMA database system for changes multiple times per day for the most up-to-date information and updates flood map update data 152 accordingly.

Upon recognition of a change to the flood map data 150 provided by FEMA or another flood map provider 104, in some implementations, the geoconverter engine 134 is configured to maintain a geospatial change table within the database representing incremental updates to FEMA shape files. In some examples, the geospatial change table may be stored in the data repository 116 as flood map update data 152. In some embodiments, the geospatial change table may include tables associated with different area sizes. For example, the geospatial change table may include two tables: one for county-level changes and one for state-level changes.

Further, the geoconverter engine 134 may be configured to generate aggregate statistics based upon the identified changes to the flood map data 150. In some implementations, the aggregate statistics may include raw and percentage change of flood zone areas per region (e.g., county and/or state). Additionally, the statistics may include metrics monitoring flood zone changes as a function of time. As with the geospatial data, the aggregate statistics may be stored in both county level and state level database tables of the flood map update data 152 for ready query access.

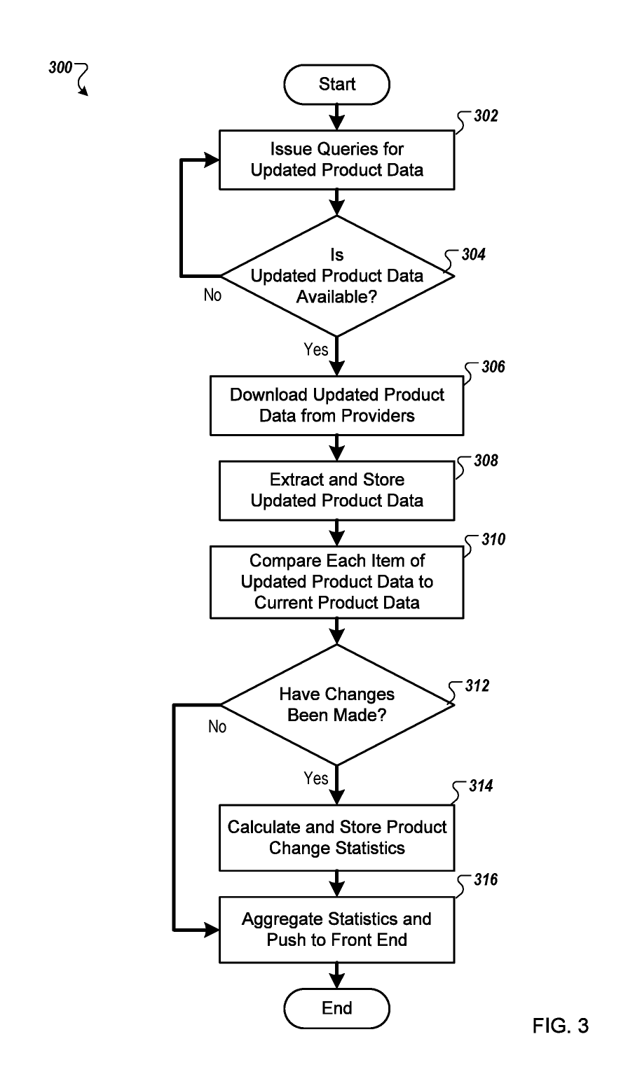

FIG. 3 illustrates a flow chart of an example method 300 for gathering flood map updates 300 one or more of the flood map providers 104. In some examples, the method is executed by the geoconverter engine 134 and data collection engine 136 (as shown in FIG. 1).

In some implementations, the method 300 begins with the data collection engine 136 issuing queries for updated product (e.g., flood map) data from one or more of the flood map providers 104 (302). In some aspects where a flood map provider 104 updates flood map data at a specific periodicity (e.g., weekly, monthly, quarterly, yearly), the data collection engine 136 may issue flood map update queries in various instances based on the update periodicities of the flood map providers 104. In some embodiments, the data collection engine 136 may also perform a web-scraping process of websites associated with the flood map providers 104 to identify flood map updates. For example, the FEMA website may provide a recent list of flood map changes covering a 45-day window. In other examples, the flood map providers 104 may issue alerts of updated flood map data to registered computing systems, such as the computing systems of the enhanced lead generation system 110. In some examples, the query for the update flood map data may include comparing a list of changes associated with a set of updated flood map data from a flood map provider 104 to a most recently-applied set of changes by the system 110 to identify the updated flood map data within a particular flood map product.

If, in some examples, updated flood map data is available (304), then the data collection engine 136 may download the updated products from the flood map providers (306). In some embodiments, a change list may be included with the flood map update data, which may be used by the data collection engine 136 to target downloads of particular regions (e.g., counties, FEMA IDs) associated with the most recent changes.

In some implementations, the geoconverter engine 134 may extract and load the flood map update data 152 into the data repository 116 via the database management engine 142 of FIG. 1 (308). For example, a new shape file for a particular county may be downloaded to a geospatial flood map database and stored as a single row in a “county shape changes” table.

The geoconverter engine 134, in some examples, may compare each item of updated flood map data 152 with a corresponding item of current flood map data 150 (310) to identify whether changes have been made (312). If, in some implementations, changes between the updated flood map data 152 and current flood map data 150 are detected, the geoconverter engine 134 may calculate and store map change statistics indicating an amount (e.g., percentage) of difference between the updated flood map data 152 and current flood map data 150 (314). Rather than storing complete sets of updated flood map data that may require vast amounts of data storage, storing the map change data as updated flood map data 152 reduces the amount of data stored in the data repository 116. Stated another way, the updated flood map data 152 may track only the changes in the files from the flood map data 150, not the files themselves.

In some examples, when a single shape file is updated, only a small portion of the shape file is affected. For example, polygonal changes between a current shape file and an updated shape file are calculated and added to the data repository 116 rather than maintaining the entire updated shape file, which may ensure that the file size of the stored files is a small fraction of the actual file type (e.g., Orange County, Fla. flood map is ˜1 GB, but a subsequent update may only change the map area by ˜1%; therefore only a 10 MB file is saved to the database). In a particular example, both county changes and state changes are maintained in geospatial shape change tables tracking polygonal differences between incremental shape files. By maintaining the original flood map shape file obtained from FEMA as flood map data 150, and then saving polygonal differences between the original and the present shape file as updated flood map data 150, on a timestamped basis, the system 110 can map the movements of the flood zones. In some examples, the movements of the flood zones can be presented within GUI screens to insurance providers 102 and can help inform brokers, and subsequently potential policy holders, as to the rate of change of flood risk in an area. Rather than maintaining only a current flood risk profile for an area, the system 110 may track the flood risk profile for an area as a function of time, which can be used to generate accurate flood risk profiles for an area.

In some examples, the geoconverter engine 134 may aggregate statistics of the updated flood maps and push the revised data to the front-end driver engine 140, where it may be reviewed by the insurance providers 102 (316). This flood map update information may be used to determine property areas that recently fell in or out of a flood zone, thus affecting the risk profile of specific properties and the surrounding areas thus providing valuable information to insurance providers 102 in real-time that was previously unavailable. In one example, the statistics information can include raw and percentage change of flood zone areas by state and/or county. Additionally, the statistics information can include national flood insurance program (NFIP) growth/shrinkage as a function of time.

Additionally, the updated flood map data calculated by the geoconverter engine 134 that indicates flood zone changes may allow the system 110 to integrate the flood zone changes with an actual flood insurance policy book for a specific area. For example, a FEMA flood zone update that adds a 10-acre tract with a housing development within the flood zone boundary may have much more impact on the policy book than the addition of 10 acres of empty fields.

Although illustrated in a particular series of events, in other implementations, the steps of the flood map update gathering process 300 may be performed in a different order. For example, extraction and loading of the updated flood map data to the data repository (308) may be performed before, after, or simultaneously with comparing the updated flood map data to the current flood map data (310). Additionally, in other embodiments, the process may include more or fewer steps while remaining within the scope and spirit of the flood map update gathering process 300.

Returning to FIG. 1, in some implementations, through the geoconverter engine 134, the enhanced lead generation system 110 can provide a consistent and scalable solution to geocoding large datasets. For example, the geoconverter engine 134 may provide an efficient process for normalizing how locations are identified within the flood maps. For example, the geoconverter engine 134 may generate coordinates (latitude and longitude, for example) from an address and vice-a-versa (e.g. Trinity College Dublin, College Green, Dublin 2, Ireland ↔ 53.3438° N, 6.2546° W) to provide consistent location identification, which streamlines processing.

In some implementations, the data collection engine 136 may be configured to communicate with one or more of the geocoding data providers 108 to facilitate the conversion of addresses into the geospatial domain. Each of the geocoding data providers 108 may provide a specific set of services with a particular level of performance and a range of costs. For example, OpenStreenMap (https://www.openstreetmap.org) by the OpenStreetMap Foundation of West Midlands, UK is a community-run organization that has built and maintains geocoding data about roads, trails, cafés, railway stations, and other geographic features around the world. And while OpenStreenMap offers free access to geocoding data, it may not include all of the geographic features used by the enhanced lead generation system 110 to produce insurance leads for the insurance providers 102, and may constrain exactly how the data is used. GeoNames (http://www.geonames.org) by Mark Wick and Unxos GmbH of Switzerland, on the other hand, may lack some of the details provided by OpenStreenMap, but it may include many additional locations and point-of-interest based on descriptive names. Mapbox (https://www.mapbox.com/) by Mapbox, Inc. of Washington D.C. and ArcGIS (https://www.arcgis.com/features/index.html) by Esri of Redlands, Calif. have substantial resources for geocoding, but have more of a price-driven data service. Finally, Google Maps (https://www.google.com/maps) by Google, Inc. of Mountain View, Calif. provides a free geocoding service, but may impose severe usage limits.

In some implementations, a first set of geocoding data providers 108 may provide a geocoding API for identifying coordinates for a passed address string. However, the first set of geocoding data providers 108 may impose severe usage limits (no more than 2,5000 requests per day and 50 requests per second, for example). These constraints may limit the viability of the first set of geocoding data providers 108. For the enhanced lead generation system 110 (shown in FIG. 1), in one example, an average dataset may include over 500,000 requests to the geocoding data providers 108.

In some embodiments, additional geocoding data providers 108 may offer similar coordinate identification features. In such implementations, the data collection engine 136 may access more than one of the geocoding data providers 108, and calculate “true” coordinates for the provided information (addresses, for example) by computing a centroid of all returned coordinate points. For example, three or more geocoding data providers 108 may be used to achieve high performance and/or accurate results. In some examples, this centroid calculation from multiple geocoding data providers 108 may allow for more accurate results for query responses for reduced quantities of queries, or a higher quantity of query responses returned at with lower accuracies.

In some implementations, the data collection engine 136 may collect data that is used to produce accurate, and up-to-date property values 158 for a given area (e.g., the United States) that may be used by the system 110 to identify properties whose owners would be considered appropriate customers for flood insurance. For example, the data collection engine 136 may gather property value data from one or more property value providers 106 that may include one or more of US government agency websites (e.g., Census.gov), local government websites (e.g., state, city, and county property sales records), research datasets (e.g., universities), private and/or public companies using published APIs (e.g., Application Programming Interfaces), and web-scraping of private and/or public websites.

In some implementations, by using web-scraping, the data collection engine 136 may gather data from a property website that includes property values for all properties within a particular region, such as a country, state, county, or city at a neighborhood level. In another example where the data collection engine 136 gathers property value information form a website that has certain limitations (e.g., only returning XML-based responses, being rate and count throttled, unknown coverage in low population areas, a minimum of API calls required to generate a property value, and only properties currently for sale are provided), the dataset produced by the data collection engine 136 may have too low of a density to build a valuable and useful property value layer. In such examples, to fully populate a neighborhood resolution geospatial layer, the data collection engine 136 may perform a combination of web-scraping and interpolation of property values, which may have a lower accuracy than performing web-scraping of a website that includes information regarding values of all or most properties.

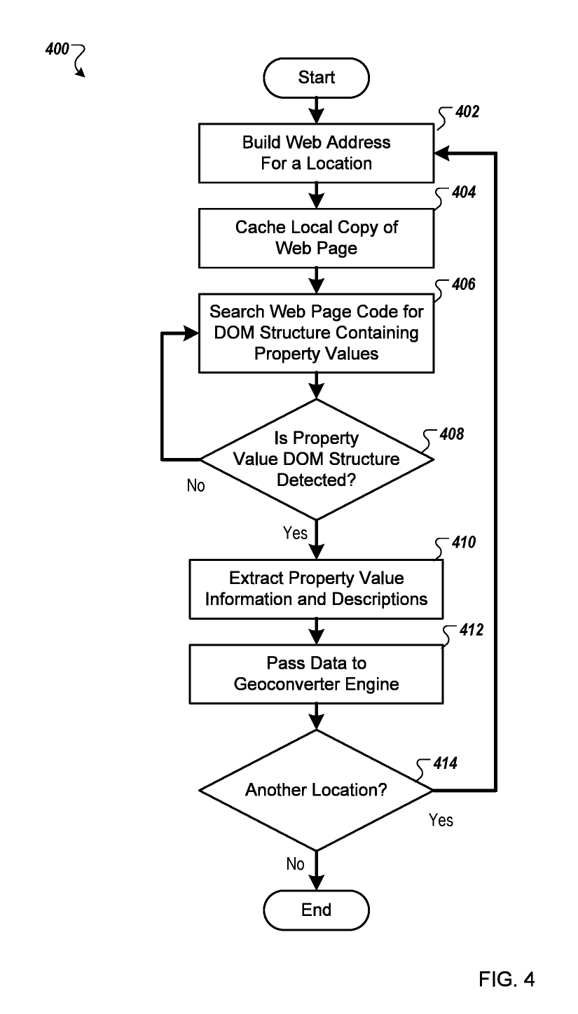

FIG. 4 illustrates a flow chart of an example method 400 for gathering property value information from one of the property value providers 106 by web-scraping, which may be executed, in some implementations, by the data collection engine 136 of the system 110. The process illustrated in FIG. 4 may be repeated for each desired state, province, or region, as necessary.

In some implementations, the method 400 begins with the data collection engine 136 building a specific web address (e.g., URL) for a particular location, such as a selected state, province, or region (402) and caching (storing a local copy of) the web page associated with the generated web address (404). In some examples, the URL may be constructed based on the particular organization and/or associated location of the target website. For example, for the state of Pennsylvania, the URL may be constructed as: https://www.realpropertyvalues.com/Pennsylvania-real-estate/.

In some examples, the data collection engine 136 may search the HTML code of the cached web page for a specific Document Object Model (DOM) structure containing the property values by neighborhood (406). For example, the DOM structure for a web page (which represents a web document as a tree structure where each node is an object representing a part or component of the document) may typically allow programs and scripts to dynamically access and update the content, structure and style of documents. Instead of using the DOM structure to manipulate the web document for display, the data collection engine 136 may use the structure to identify the content that relates to property values.

If, in some embodiments, the specific DOM structure that includes the property values is detected (408), then the data collection engine 136 may extract the property value data and property descriptions from the web page using the DOM structure as a guide (410), and, in some examples, may save and/or pass this data to the geoconverter engine 134 (412) which may process the data to create a data overlay on a geospatial layer for inspection and further refinement. In some implementations, if there is another location to gather property values for (414), then the data collection engine 136 may return to the beginning of the method 200 to build another web address for the next property value location (402).

Although illustrated in a particular series of events, in other implementations, the steps of the property value information gathering process 400 may be performed in a different order. For example, extraction and saving of the property values and descriptions (410) may be performed before, after, or simultaneously with passing property values and descriptions to the geoconverter engine 134 (412). Additionally, in other embodiments, the process may include more or fewer steps while remaining within the scope and spirit of the property value information gathering process 400.

Returning to FIG. 1, in some implementations, the enhanced lead generation system 110 may also include a real-time notification engine 148 that ensures that data input to the enhanced lead generation system 110 is processed in real-time. In addition, the processes executed by the real-time notification engine 148 ensure interactions between the insurance providers 102 and the enhanced lead generation system 110 are processed in real-time. For example, the real-time notification engine 148 may output alerts and notifications to the insurance providers 102 via the UI screens when data associated with the insurance providers 102 have been received by the data collection engine 136.

In some examples, the enhanced lead generation system 110 may also include an event trigger engine 132, which can manage the flow of data updates to the enhanced lead generation system 110. For example, the event trigger engine 132 may detect updates to flood map data 150, property values 158, or any other type of data collected or controlled by the enhanced lead generation system 110. The event trigger engine 132 may also detect modifications or additions to the files of the data repository 116, which may indicate that new or updated data has been received. When a data update is detected at data repository 116, the event trigger engine 132 loads the updated data files to a data extraction engine 144. The event trigger engine 132 operates in real-time to update the data extraction engine 144 when updated data is received from the data sources. In addition, the event trigger engine 132 operates automatically when updated data is detected at the data repository 116.

In some implementations, the front-end driver engine 140 may use intersected flood zone and property parcel layers to generate new geospatial data layers that capture properties located within mandatory flood zones, the zone type, and the total area and distribution of such zones. Generating the geospatial data provides the ability to clearly identify properties in mandatory flood areas. This information was not available prior to this work and the resulting data proved to be valuable for determining nearby non-mandatory property flood risk.

In some examples, storing and querying large volumes of geospatial data may impose limits on transfer of data between the database management engine 142 and the front-end driver engine 140 (and, ultimately to insurance providers 102 and external devices) because geospatial files are typically very large. Although data compression of the files may reduce the size and improve transfer performance, the high computational cost may limit real-time applications. In addition, set transformations (i.e. intersections) within the geospatial data may fail to produce appropriate results due to so-called “self-intersections,” which can occur when a geospatial data generation method generates shapes that cross themselves, which may lead to poor shape file integrity.

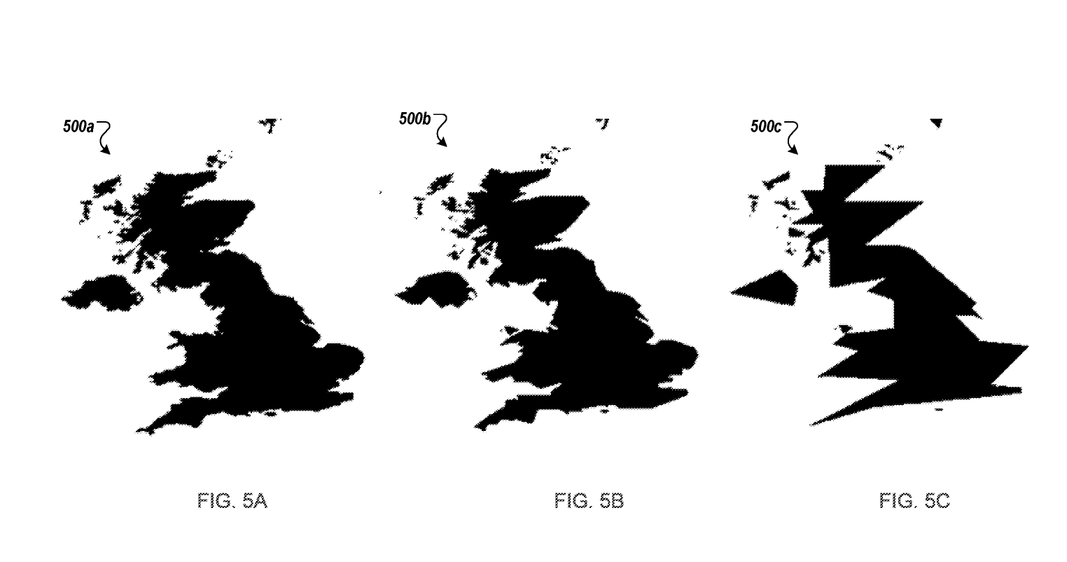

To address the geospatial file size issues so that the enhanced lead generation system 110 can present dynamically updated flood maps affected properties on user interface screens in real-time in response to queries, the geoserver engine 162 may execute processes to reduce file size to improve performance when delivering data to multiple users at multiple scales (e.g. neighborhood, county, state, and regional levels). In some implementations, the geoserver engine 162 may execute a process to simplify the geospatial geometry to reduce geospatial file size and limit the effect of the self-intersection problem discussed above. For example, FIGS. 5A-5C illustrate the effect of simplification of the geospatial geometry on a geospatial file.

FIG. 5A illustrates an exemplary geospatial file 500a. As illustrated, the geospatial file 500a includes connected points that define, for example, an outline of land masses, borders of countries, states or cities, an area of a river basin, or boundaries of other geographic objects as well as boundaries of various types of flood hazards. Typical geospatial files, like that geospatial file 500a, may be created from high resolution images, drawings, and/or maps to preserve details of each geographic object. Therefore, there may be many points that define the outline of each shape, and the distance between each pair of points may be quite small. By reducing the number of points that define each shape, the geospatial file size may be significantly reduced. This process of reducing the number of points that define a geospatial object, generically known as “polygonal curve (or surface) simplification,” may involve removing points from geospatial shape structures such that the shapes retain as many of their important, shape-defining features as possible. Stated another way, the shape simplification may be performed such that a distance from any point on an approximated (e.g., simplified) shape to the closest point on the original shape is within some error bound a

In some implementations, to simplify curves that are part of a map segment polygonal shape, the geospatial server engine 162 may apply an algorithm to fit a series of line segments to the curve. For example, the algorithm may approximate a sequence of points that make up a curve by a generating a line segment between end points of the curve (e.g., from a first point to last point). The point farthest from this line segment is identified, and if the distance between the line segment and the farthest point is less than an error threshold, the approximation is accepted, otherwise the geospatial server engine 162 may recursively apply the line segment fitting algorithm to the two sequences of points on either side of the farthest point. In some examples, the algorithm can produce high quality shape fitting approximations when compared with many other heuristic algorithms. To control the bounds of the change between the original polygon and the simplified polygon, an algorithm may be applied to measure distances of two subsets (e.g., curve segment vs. series of line segments) of the metric space produced by the simplification algorithm. In a particular example, the distance verification may be performed for one or more points in each subset that have greater than a threshold separation distance between one another.

FIG. 5B illustrates a simplified geospatial file 500b that is generated by the geoserver engine 162 of the enhanced lead generation system 110 in response to applying a mildly aggressive curve simplification to geospatial file 500a illustrated in FIG. 5A. FIG. 5C illustrates a simplified geospatial file 500c that is generated by applying a more aggressive curve simplification on the geospatial file 500a. In some examples, the amount of aggressiveness of the curve simplification algorithm may be based on the threshold of acceptable distance between the original polygon and the simplified polygon. For example, a more aggressive curve simplification algorithm may have an acceptable threshold distance between the original and simplified polygons that is greater than the acceptable threshold distance for a less aggressive simplification algorithm. Stated another way, the more aggressive curve simplification algorithm may generate a geospatial file shape with a fewer numbers of points than a less aggressive curve simplification algorithm.

In some implementations, the amount of aggressiveness of curve simplification may be based on one or more factors, which may include amount of geospatial file data storage and/or processing speed of the computing systems of the enhanced lead generation system 110. For example, the use of curve simplification may shrink a database size by approximately 60%, which may allow for faster set transformations to be applied. Additionally, the geospatial file simplification may also help ameliorate the self-intersection problems of geospatial files by reducing the number of edges and therefore reducing the number of self-intersecting lines.

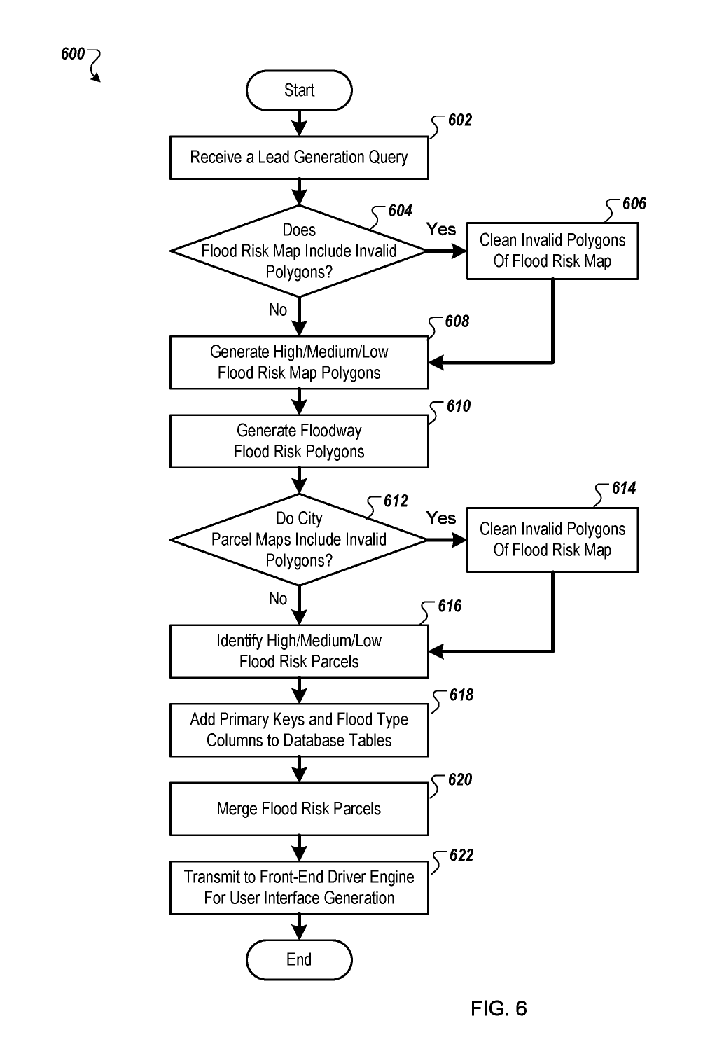

Turning to FIG. 6, a flow chart of an example method 600 for preparing multi-layer flood risk map visualizations. In some examples, the method 600 is executed by the geoserver engine 162 that generates one or more database access functions to query the database management engine 142 during preparation of multi-layer flood risk map visualizations.

In some implementations, the method 600 commences with receiving a lead generation query at a user interface screen, which may include a visual selection of an area or point (on a map displayed within the user interface, for example) indicating a desired location of properties for lead generation (602). In some examples, if one or more geospatial files of flood risk map (e.g., a FEMA Flood Risk Insurance Map) associated with a query location include “invalid” polygons (polygons that, for example, are not topologically closed, have disconnected interior regions, have self-intersections, etc.) (604), then the geoserver engine 162 may clean or repair the invalid polygons (606) within the flood risk map.

The geoserver engine 162, in some examples, may generate high, medium, and low flood risk map polygons from the cleaned flood risk map polygons (608). In some embodiments, spatial union and simplification operations such as the simplification algorithm described in FIGS. 5A-5C may be performed to identify and simplify the high, medium, and low flood risk zones from the flood risk map.

In some implementations, the geoserver engine 162 may generate floodway flood risk map polygons from the cleaned flood risk map polygons (610), which may also include performing spatial union and simplification operations may be performed to identify and simplify the floodway flood risk zones from the flood risk map.

If, in some implementations, one or more files of a city parcel map associated with the query location include invalid polygons (612), then the geoserver engine 162 may clean the polygons of a city parcel map (614). In some examples, the city parcel map may illustrate boundaries for a number of real estate parcels located within a specified region (a city, for example).

The geoserver engine 162, in some examples, may generate high flood risk parcels from the cleaned flood risk map polygons and the cleaned city parcel polygons (616). For example, the geoserver engine 162 may identify real estate parcels that lie within each of the high, medium, and low flood risk zones.

In certain embodiments, the geoserver engine 162 may add primary keys and flood type columns to database tables associated with the received query (618), and in some examples, may merge flood risk parcels together to create a final flood parcel table (620). In some implementations, the final flood risk tables and geospatial files may be transmitted to the front-end driver engine 140 to be configured into a flood risk analytics user interface screen (622).

Although illustrated in a particular series of events, in other implementations, the steps of the multi-layer flood risk map visualization preparation process 600 may be performed in a different order. For example, generation of the floodway flood risk polygons (610) may be performed before, after, or simultaneously with generating the high, medium, and low risk flood risk map polygons (608). Additionally, in other embodiments, the process may include more or fewer steps while remaining within the scope and spirit of the multi-layer flood risk map visualization preparation process 600.

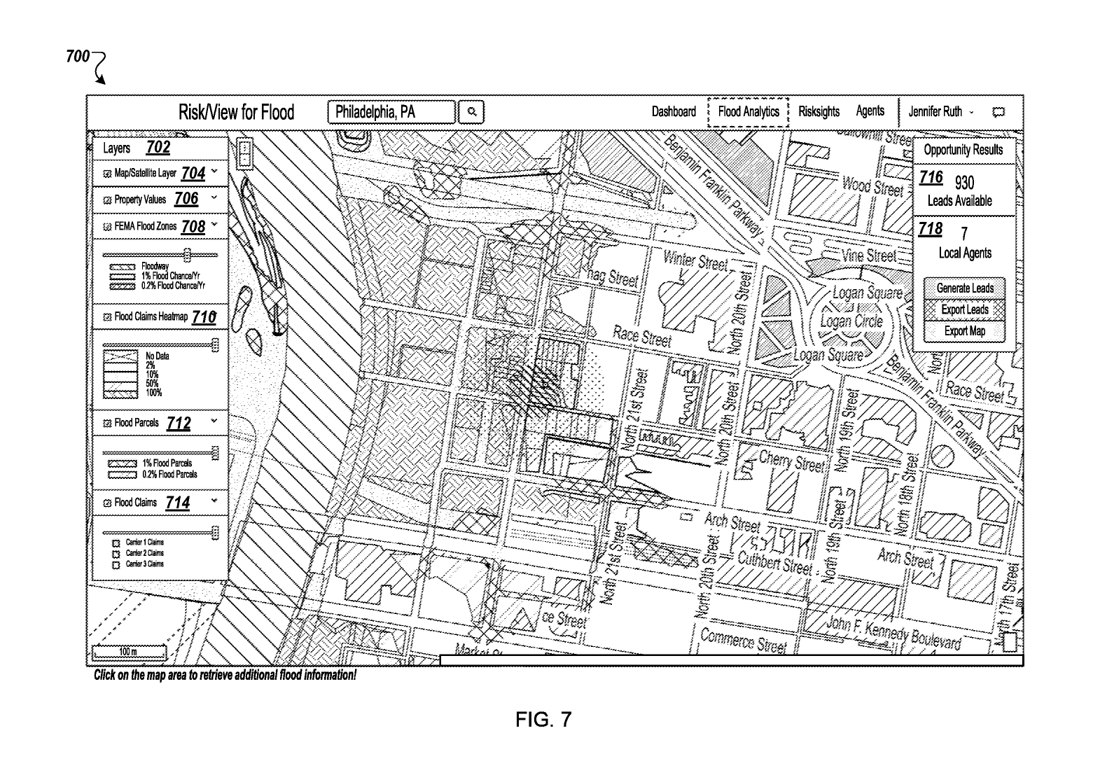

FIG. 7 illustrates an example flood risk analytics user interface screen 700 that can be dynamically generated in real-time by the enhanced lead generation system 110 in response to a user query. In some implementations, the user interface screen 700 may include one or more information layers 702 that can be selectively displayed within the user interface screen 700 that provide information related to flood zones locations, claims that have been reported within the various flood zones, and properties located within each of the flood zones. For example, the layers 702 may include a satellite/street map 704, property values 706, FEMA flood zones 708, a flood claims heat map 710, property parcels located within flood zones and floodways 712, and individual flood claims for one or more insurance carriers. In some implementations, the user interface screen 700 may provide users an interactive experience in which the information provided to the user can be dynamically updated in real-time in response to selections made at the user interface screen 700. For example, the front-end driver engine 140 can dynamically update the user interface screen 700 in response to selection or deselection of one of the information layers 702. Additionally, the user interface screen 700 may present data related to the number of leads 716 that are available within the displayed location along with the local insurance agents 718 associated with each of the leads 716. In some examples, as the user zooms in or zooms out on the map displayed within the user interface screen 700, the number of leads 716 and corresponding local agents 718 may be dynamically updated in real-time to reflect the displayed location.

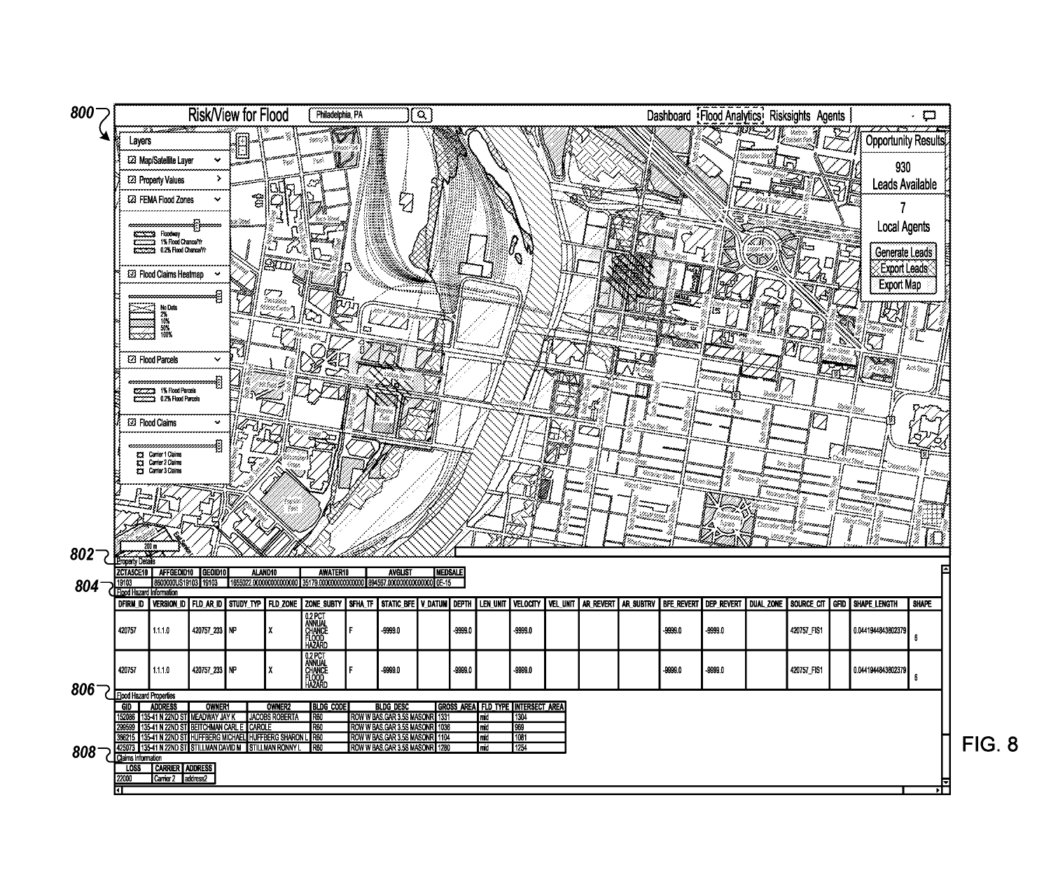

FIG. 8 illustrates another example flood risk analytics user interface screen 800 that can be dynamically generated in real-time by the enhanced lead generation system 110 in response to a user query. In some implementations, in addition to the information provided in the user interface screen 700, the user interface screen 800 can also provide additional information regarding a selected area of the map in one or more tables presented below the map. The additional information may include property details for the selected area 802 (addresses, owners, building descriptions, etc.), specific flood hazard information 804, properties that fall within flood hazards 806, claims details 808, and other information pertinent to evaluating the flood insurance opportunities in the selected area.

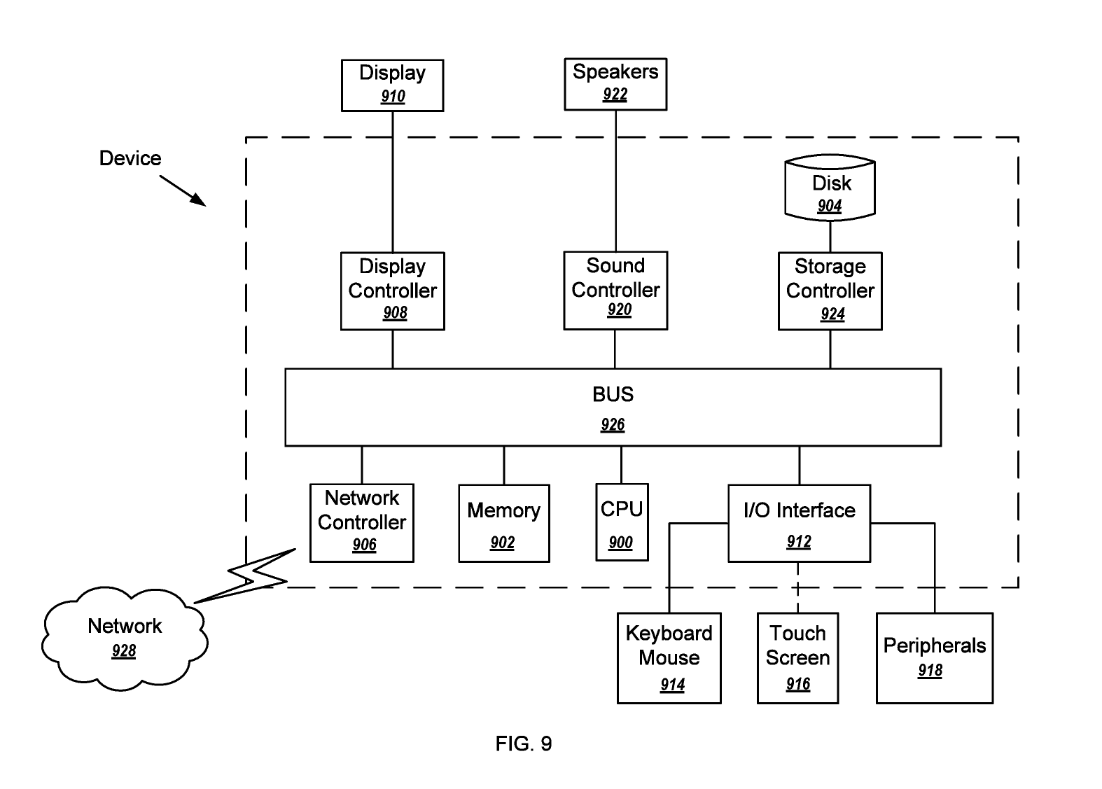

Next, a hardware description of the computing device, mobile computing device, or server according to exemplary embodiments is described with reference to FIG. 9. The computing device, for example, may represent the flood map providers 104, the property value providers 106, the geocoding data providers 108, the insurance providers 102, or one or more computing systems supporting the functionality of the enhanced lead generation system 110, as illustrated in FIG. 1. In FIG. 9, the computing device, mobile computing device, or server includes a CPU 900 which performs the processes described above. The process data and instructions may be stored in memory 902. The processing circuitry and stored instructions may enable the computing device to perform, in some examples, the method 200 of FIG. 2, the method 300 of FIG. 3, the method 400 of FIG. 4, or the method 600 of FIG. 6, These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer. The storage medium disk 904, in some examples, may store the contents of the data repository 116 of FIG. 1, as well as the data maintained by the flood map providers 104, the property value providers 106, the geocoding data providers 108, and the insurance providers 102 prior to accessing by the enhanced lead generation system 110 and transferring to the data repository 116.

Further, a portion of the claimed advancements may be provided as a utility application, background daemon, or component of an operating system, or combination thereof, executing in conjunction with CPU 900 and an operating system such as Microsoft Windows 9, UNIX, Solaris, LINUX, Apple MAC-OS and other systems known to those skilled in the art.

CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The computing device, mobile computing device, or server in FIG. 9 also includes a network controller 906, such as an Intel Ethernet PRO network interface card from Intel Corporation of America, for interfacing with network 928. As can be appreciated, the network 928 can be a public network, such as the Internet, or a private network such as an LAN or WAN network, or any combination thereof and can also include PSTN or ISDN sub-networks. The network 928 can also be wired, such as an Ethernet network, or can be wireless such as a cellular network including EDGE, 9G and 4G wireless cellular systems. The wireless network can also be Wi-Fi, Bluetooth, or any other wireless form of communication that is known. The network 928, for example, may support communications between the enhanced lead generation system 110 and any one of the flood map providers 104, the property value providers 106, the geocoding data providers 108, and the insurance providers 102.

The computing device, mobile computing device, or server further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard. The display controller 908 and display 910 may enable presentation of the user interfaces illustrated, in some examples, in FIGS. 5A-5C, FIG. 7, and FIG. 8.

A sound controller 920 is also provided in the computing device, mobile computing device, or server, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the computing device, mobile computing device, or server. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

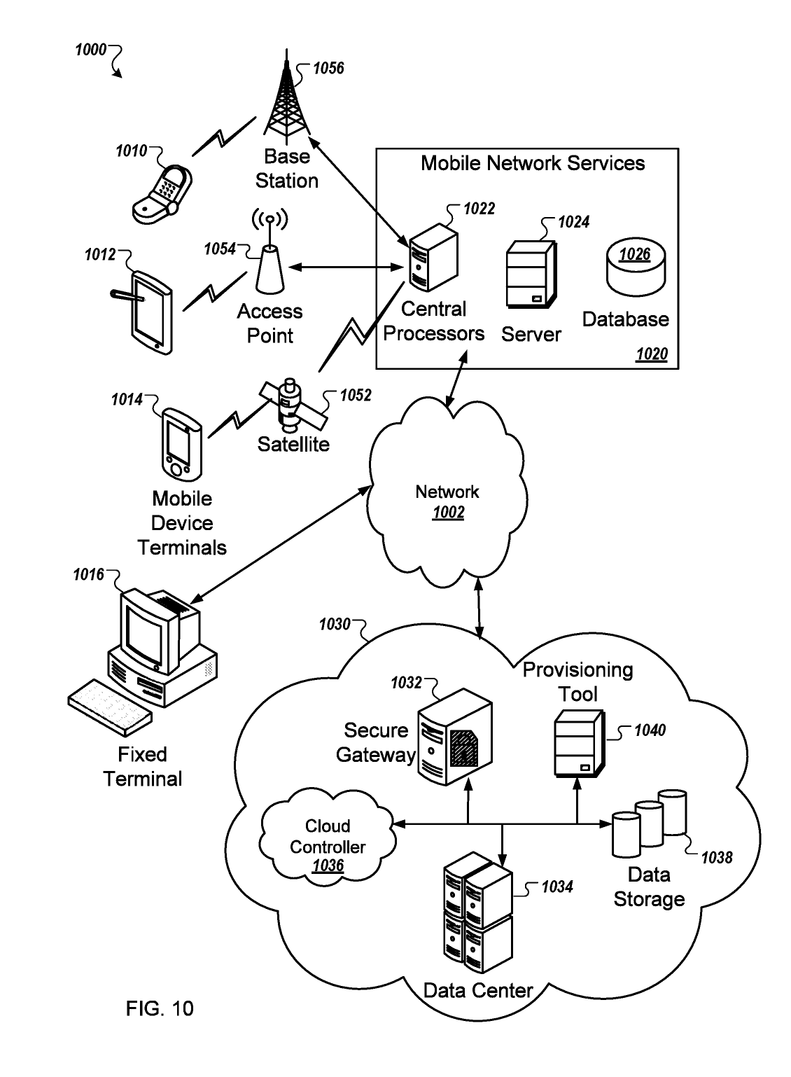

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 10, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1030, such as Google Cloud Platform™ to perform at least portions of methods or algorithms detailed above. The processes associated with the methods described herein can be executed on a computation processor, such as the Google Compute Engine by data center 1034. The data center 1034, for example, can also include an application processor, such as the Google App Engine, that can be used as the interface with the systems described herein to receive data and output corresponding information. The cloud computing environment 1030 may also include one or more databases 1038 or other data storage, such as cloud storage and a query database. In some implementations, the cloud storage database 1038, such as the Google Cloud Storage, may store processed and unprocessed data supplied by systems described herein. For example, the flood map data 150, flood map update data 152, claims data 154, customer data 156, property characteristics 157, and/or property values 158 may be maintained by the enhanced lead generation system 110 of FIG. 1 in a database structure such as the databases 1038.

The systems described herein may communicate with the cloud computing environment 1030 through a secure gateway 1032. In some implementations, the secure gateway 1032 includes a database querying interface, such as the Google BigQuery platform. The data querying interface, for example, may support access by the enhanced lead generation system 110 to data stored on any one of the geocoding data providers 108, the property value providers 106, the flood map providers 104, and the insurance providers 102.

The cloud computing environment 102 may include a provisioning tool 1040 for resource management. The provisioning tool 1040 may be connected to the computing devices of a data center 1034 to facilitate the provision of computing resources of the data center 1034. The provisioning tool 1040 may receive a request for a computing resource via the secure gateway 1032 or a cloud controller 1036. The provisioning tool 1040 may facilitate a connection to a particular computing device of the data center 1034.

A network 1002 represents one or more networks, such as the Internet, connecting the cloud environment 1030 to a number of client devices such as, in some examples, a cellular telephone 1010, a tablet computer 1012, a mobile computing device 1014, and a desktop computing device 1016. The network 1002 can also communicate via wireless networks using a variety of mobile network services 1020 such as Wi-Fi, Bluetooth, cellular networks including EDGE, 3G and 10G wireless cellular systems, or any other wireless form of communication that is known. In some examples, the wireless network services 1020 may include central processors 1022, servers 1024, and databases 1026. In some embodiments, the network 1002 is agnostic to local interfaces and networks associated with the client devices to allow for integration of the local interfaces and networks configured to perform the processes described herein. Additionally, external devices such as the cellular telephone 1010, tablet computer 1012, and mobile computing device 1014 may communicate with the mobile network services 1020 via a base station 1056, access point 1054, and/or satellite 1052.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, some implementations may be performed on modules or hardware not identical to those described. Accordingly, other implementations are within the scope that may be claimed.

Aspects of the present disclosure may be directed to using proprietary insurance claims history data and statistical modelling of probable flood damage to tie the risk of flood loss back to property leads to find those that satisfy the optimal risk-return ratios. In some implementations, the enhanced lead generation system 110 may perform accurate, real-time geocoding (converting street addresses, or other descriptive information, into geographic coordinates) to identify leads positioned within identified flood zones. Further, in some examples, the system 110 may determine accurate and up-to-date property values across a community regardless of the type or status of the property (e.g., residential, commercial, for sale, off market, etc.) based upon location representations and publicly available property estimates. In addition, the system 110 may generate insights surrounding potential flood insurance customers that allow unprecedented control over building a flood insurance portfolio as a function of customers' property risk-to-return ratio. The analytics tools provided by the enhanced lead generation system 110 can deliver an unprecedented combination of market insights to insurance providers, financial institutions, and government agencies and generate leads for flood insurance by identifying properties whose owners would be considered appropriate customers for flood insurance.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that it is intended that the feature or function may be deployed, utilized or implemented in connection with the alternative embodiment unless the feature or function is incompatible with the alternative embodiment.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system comprising:
processing circuitry;
a non-transitory database storage region; and
a non-transitory computer readable memory coupled to the processing circuitry, the memory storing machine-executable instructions, wherein the machine-executable instructions, when executed on the processing circuitry, cause the processing circuitry to
receive, from a remote computing device via a network, a lead generation request for one or more prospective insurance leads for a geographic area, wherein the one or more insurance leads include properties located within or affected by a hazard,
construct, responsive to receiving the lead generation request, a database query for one or more data files associated with the lead generation request based on the geographic area, wherein the one or more data files include at least one hazard data file representing one or more hazard zones,
adjust, based on hazard data updates received from one or more hazard data providers, the at least one hazard data file to incorporate the hazard data updates,
apply, based on data sizes of the one or more data files, a shape approximation algorithm to geographic shape representations of the geographic area within the one or more data files, and
generate, in real-time responsive to receiving the lead generation request, a lead generation user interface screen presenting the one or more prospective insurance leads within a map incorporating the approximated geographic shape representations.

2. The system of claim 1, wherein the lead generation query received from the remote computing device includes selection of a lead generation location on a map presented within a user interface screen.

3. The system of claim 1, wherein the hazard includes a flood hazard.

4. The system of claim 1, wherein the one or more data files include geospatial data files representing at least one of the geographic area and the one or more hazard zones.

5. The system of claim 1, wherein the machine-executable instructions, when executed on the processing circuitry, further cause the processing circuitry to:
identify, based on identification of a property value data structure through Internet search, one or more property parcels positioned within the geographic area.

6. The system of claim 5, wherein identifying the property value data structure comprises performing a web scraping operation of at least a portion of one web site.

7. The system of claim 5, wherein the machine-executable instructions, when executed on the processing circuitry, further cause the processing circuitry to:
identify, from the one or more property parcels within the geographic area, the one or more prospective insurance leads based on at least one of property values, distance from properties to the one or more hazard zones, distribution of the one or more hazard zones, and historical claims data for the geographic area.

8. The system of claim 1, wherein the machine-executable instructions, when executed on the processing circuitry, further cause the processing circuitry to:
detect, at predetermined time intervals, hazard data updates from the one or more hazard data providers, wherein the hazard data updates include adjustments to boundaries of the one or more hazard zones.

9. The system of claim 8, wherein the machine-executable instructions, when executed on the processing circuitry, further cause the processing circuitry to:
calculate, responsive to detecting hazard data updates from the one or more hazard data providers, data change statistics indicating an amount of difference between a current set of data files and an updated set of data files; and
store, within a portion of the non-transitory data storage region, a hazard data update table including the data change statistics.

10. The system of claim 9, wherein adjusting the at least one hazard data file to incorporate the hazard data updates includes applying the data change statistics within the hazard data update table to the current set of data files.

11. The system of claim 1, wherein applying the shape approximation algorithm includes reducing a number of points defining the geographic shapes of the one or more data files.

12. The system of claim 11, wherein applying the shape approximation algorithm further includes determining an amount of aggressiveness of the shape approximation algorithm based on at least one of an amount of data storage and processing capacity.

13. The system of claim 1, wherein generating the lead generation user interface screen includes dynamically displaying, responsive to user selection, one or more visualization layers providing hazard information for the geographic area.

14. The system of claim 13, wherein the one or more visualization layers include at least one of a property value layer, a hazard risk layer, a historical claim data layer, a flood risk property layer, and a map/satellite layer.

15. A method comprising:
receiving, from a remote computing device via a network, a lead generation request for one or more product leads for a geographic area, wherein the one or more product leads include properties affected by an incident;
constructing, by processing circuitry responsive to receiving the lead generation request, a database query for one or more data files associated with the lead generation request based on the geographic area, wherein the one or more data files include at least one incident data file representing one or more incident zones;
detecting, by the processing circuitry at predetermined time intervals, incident data updates from one or more incident data providers, wherein the incident data updates include adjustments to boundaries of the one or more incident zones;
adjusting, by the processing circuitry based on the incident data updates received from the one or more incident data providers, the at least one incident data file to incorporate the incident data updates; and
generating, by the processing circuitry in real-time responsive to receiving the lead generation request, a lead generation user interface screen presenting the one or more prospective product leads within a map incorporating visual representations of the one or more data files.

16. The method of claim 15, further comprising:
calculating, responsive to detecting incident data updates from the one or more incident data providers, data change statistics indicating an amount of difference between a current set of data files and an updated set of data files; and
storing, within a portion of a non-transitory data storage region, an incident data update table including the data change statistics.

17. The method of claim 16, wherein adjusting the at least one incident data file to incorporate the incident data updates includes applying the data change statistics within the incident data update table to the current set of data files.

18. The method of claim 15, wherein the one or more data files include geospatial data files.

19. The method of claim 18, further comprising applying, based on data sizes of the one or more data files, a shape approximation algorithm to the geospatial data files.

20. The method of claim 19, wherein applying the shape approximation algorithm further includes reducing a number of points defining the geospatial data files.
